(19) United States
(12) Patent Application Publication
(10) Pub. No.: US 2026/0175281 A1
(43) Pub. Date: Jun. 25, 2026

(54) TOOL FOR ASSEMBLING ELEMENTS EQUIPPED WITH FLAP

(71) Applicant: SOLTEC INNOVATIONS, S.L., Molina de Segura (ES)

(72) Inventors: Francisco Javier CARPIO OBRÉ, Molina de Segura (ES); Jose Antonio CHUSA ROMAN, Molina de Segura (ES)

(73) Assignee: SOLTEC INNOVATIONS, S.L., Molina de Segura (ES)

(21) Appl. No.: 18/728,886

(22) PCT Filed: Jun. 23, 2022
(86) PCT No.: PCT/ES2022/070399

§ 371 Date: Jul. 14, 2024

(30) Foreign Application Priority Data
Jan. 14, 2022 (ES) U202230054

(51) Int. Cl. B21D 39/03; F16B 5/04; F24S 25/60; F24S 25/63; H02S 20/32; H02S 30/10

(52) U.S. Cl. CPC B21D 39/032; F16B 5/045; F24S 25/63; H02S 20/32; H02S 30/10; F24S 2025/6009

(57) ABSTRACT

The tool enables the attachment of: a solar panel frame, with a first flap with first eyelets; and solar tracker profile, with a second flap and a ferrule, and includes a head, with: punch; die facing the punch; and front housing between die and punch, to house the profile together with the frame prior to using the tool, movement mechanism, for relative approach between punch and die; a power supply; actuator of the movement mechanism; and distal handle, opposite the head, for gripping by the operator, wherein the relative approach causes the punch to make contact with the ferrule, pressing and deforming said ferrule, to expand it around the first eyelet and attach frame and profile via the flaps.

### TECHNICAL FIELD

The present invention can be included within the construction sector. More specifically, the object of the invention relates to a tool for mechanically fixing elements equipped with flaps together, connecting the flaps thereof through eyelets. According to a preferred exemplary embodiment, the tool is applicable in the solar panel sector, to connect a frame of a solar panel with an omega profile of a tracker on which the solar panel is supported.

### BACKGROUND

A common configuration of a solar installation with tracking includes solar trackers that support solar panels, to provide said panels with a rotation that enables the panels to be oriented according to the solar position. Usually, the panels are supported on the tracker such that the frame of each solar panel is fixed to an omega profile comprised in the tracker, by means of solutions that involve the use of additional elements, such as rivet and washer assemblies, or a component, offered by the Vespro Solar company, in the shape of a plate bent at 60°, with a series of slots, hollows and bores.

### DESCRIPTION OF THE INVENTION

The present invention discloses a tool for attaching elements equipped with flaps, for example, a profile, such as an omega profile, of a solar tracker, and a frame of a solar panel, without the need to use additional attachment elements.

The present invention relates to a tool according to the independent claim. The dependent claims define further optional features and advantages.

The tool described is portable and self-powered, it also enables elements to be attached by the flaps thereof without the need to use additional attachment elements.

### BRIEF DESCRIPTION OF THE FIGURES

The foregoing and other advantages and features will be more fully understood from the following detailed description of exemplary embodiments with reference to the accompanying drawings, which should be considered by way of illustration and not limitation, wherein:

FIGS. 1A and 1B show respective perspective views of an omega profile and a solar panel frame wherein the eyelets and the ferrule can be seen (FIG. 1A), as well as in a position prior to being attached by means of the tool of the invention (FIG. 1B).

FIG. 2 shows a perspective view of the tool of the invention.

FIG. 3 shows a detailed perspective view of the head of the tool of FIG. 2 ready for operation.

FIG. 4 shows a detailed rear view of the head of the tool of FIG. 2.

FIG. 5 shows a detailed rear view of the head during operation.

### List of references

1 Tool
2 First flap
3 Second flap
4 Frame
5 Spring
6 Profile
7 First eyelets
8 Second eyelets
9 Ferrule
10 Head
11 Supporting frame
12 Punch
13 Punch holder
14 Die
15 Die holder
16 Housing
17 Power supply
18 Handle
19 Ledge
20 Guide bolts
21 Guides
22 Thrust bolt
23 Bore
24 Limiter
25 Hole
26 Stop

### DETAILED DESCRIPTION OF AN EXEMPLARY EMBODIMENT

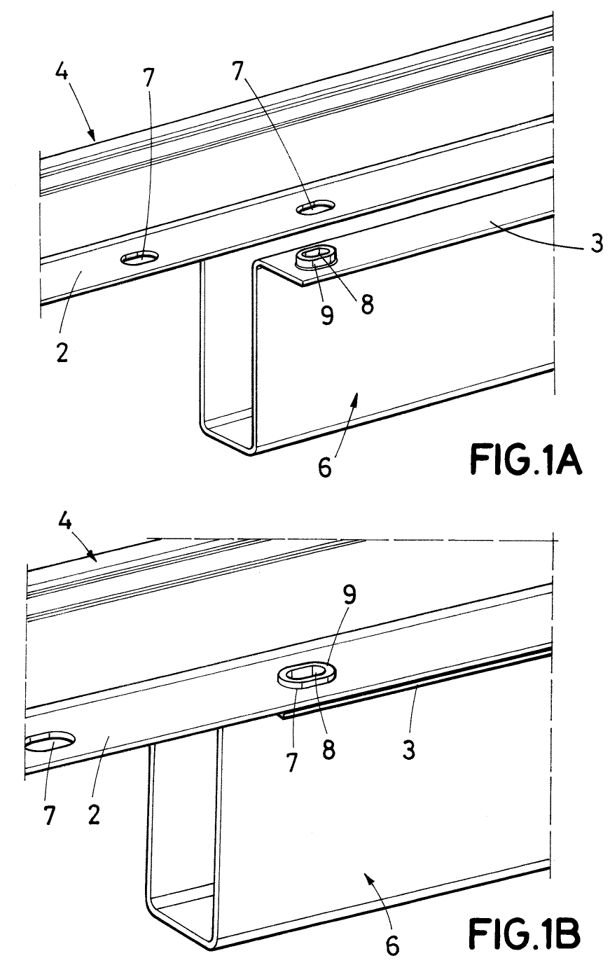

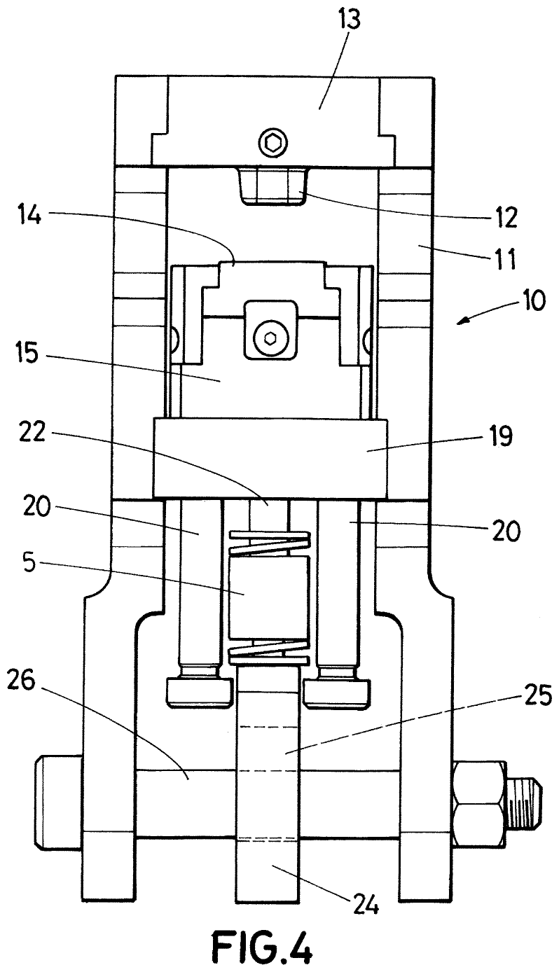

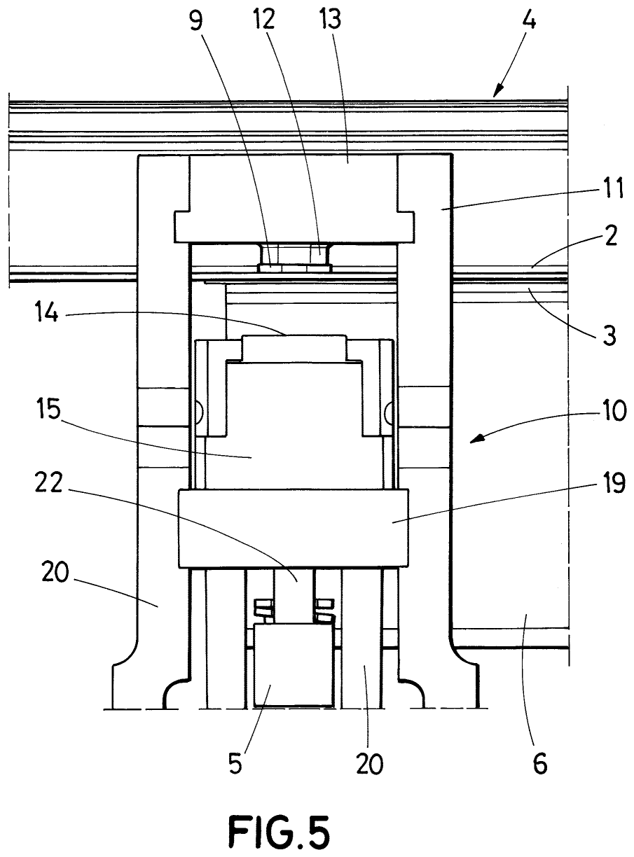

Next, with the help of the aforementioned attached FIGS. 1-5, a detailed description is provided of a preferred exemplary embodiment of a tool (1) for fixing a first element and a second element together, both equipped with flaps (2, 3), according to the present invention, according to a preferred applicable example wherein the first element comprises a frame (4) of a solar panel (not shown), which includes a first flap (2), while the second element comprises a profile (6), such as an omega profile (6), equipped with a second flap (3), and intended to support the solar panel on a solar tracker (not shown).

FIG. 1A shows a view of the frame (4) of the solar panel, wherein the first flap (2), equipped with first eyelets (7), can be seen. Likewise, FIG. 1A itself shows a view of the omega profile (6), wherein the second flap (3) can be seen, which is equipped with second eyelets (8), with a shape corresponding to the first eyelets (7). The first eyelets (7) and the second eyelets (8) are preferably elongated, for example, in the form of slotted holes, although they can also be curved, or in other shapes. Around each second eyelet (8), a rim can be seen, also called “ferrule” (9), which is formed by material from the second flap (3) that has been moved, although not torn, from the profile (6), when making the second eyelet (8). Preferably, each ferrule (9) has a dimension slightly smaller than that of the corresponding first eyelet (7).

Usually, solar panels are provided from the factory with the first eyelets (7). In accordance with the present invention, the second eyelets (8) are additionally made in the second flaps (3), in this case the wings of the omega profiles (6) that support the solar panels on the solar tracker, producing the aforementioned ferrule (9) so that said ferrule (9) can be housed in the first eyelet (7) prior to the intervention of the tool (1) of the invention, as explained below.

By way of illustrative example, the second eyelets (8), together with the corresponding ferrules (9) thereof, both made in the omega profile (6) of the solar panel (6), are executed by means of a die (not shown), for example, manually powered from the omega profiles (6), and equipped with eyelet punches (not shown) that make the dies in previously defined positions, and produce the ferrules (9) on the side of the profile (6) that is opposite the side from which the punches attack.

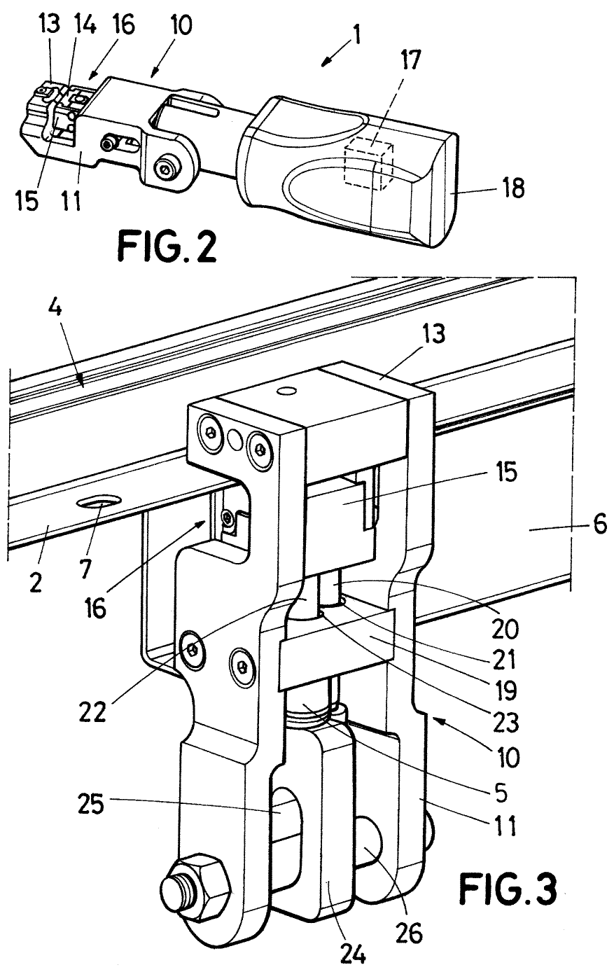

The tool (1), as shown in FIG. 2, is configured so that, once the omega profile (6) and the frame (4) are facing each other, and having passed the ferrule (9) of the profile (6) through the first eyelet (7) of the frame (4), said ferrule (9) protruding from the first eyelet (7), the tool (1) deforms the ferrule (9) so that the ferrule (9) expands and surrounds the first eyelet (7), causing a form-fit that fixes the profile (6) to the frame (4).

To carry out the above function, the tool (1), see FIGS. 3-5, comprises a head (10), located in a proximal position, with respect to the elements to be attached, which are the omega profile (6) and the frame (4) of the solar panel. The head (10) includes a supporting frame (11), as well as a punch (12) mounted on a punch holder (13) supported on the supporting frame (11). The head (10) further includes a die (14) supported on a die holder (15), also linked to the supporting frame (11), the die (14) facing the punch (12), a front housing (16) being defined between the die (14) and the punch (12), which enables the omega profile (6) to be housed together with the frame (4). According to a preferred example, the tool (1) is configured to be able to exchange punches (12) of different dimensions, either because the punch (12) is separately mounted in the punch holder (13), or because the punch holder (13) itself is releasable with respect to the supporting frame (11). The same thing occurs with respect to the die (14), the die (14) being able to be releasably mounted in the die holder (15), or the die holder (15) being releasable from the frame (11).

The tool (1) additionally comprises a movement mechanism, to produce a relative approach between the punch (12) and the die (14). In the embodiment shown, the punch holder (13) is fixed to the supporting frame (11), while the die holder (15) is movably linked to the supporting frame (11), the movement mechanism being configured to act on the die holder (15), moving said die holder (15) to bring it closer to the punch holder (13).

To drive the movement mechanism, the tool (1) comprises an actuator (not shown) powered by a power supply (17). As a power supply (17), the tool (1) can include a mains plug-in socket, although, more preferably, the tool (1) includes a rechargeable battery, as shown in the figures.

Finally, the tool (1) includes a handle (18), in a distal position, i.e., opposite the head (10), to enable it to be gripped by an operator. Preferably, the power supply (17), in particular the battery, as well as the actuator, are housed in the handle (18).

Likewise, according to the embodiment illustrated in the figures, the die holder (15) is moveable from an initial position, wherein the die holder (15) rests on a ledge (19) linked to, or comprised in, the supporting frame (11), towards the punch holder (13). The die holder (15) is fixed to a plurality of guide bolts (20), for example two guide bolts (20), which pass through guides (21) made in the ledge (19).

Likewise, a thrust bolt (22) is included that passes through the ledge (19) through a through bore (23) made in the ledge (19), for example, between the guides (21). The mission of the thrust bolt (22) is to push the die holder (15) to bring it closer to the punch holder (13).

The tool (1) can include a limiter (24) to limit the movement of the die holder (15). In particular, the limiter (24) can be actuated by means of the actuator, receiving a movement that is transmitted to the die holder (15) through the thrust bolt (22), the limiter (24) being configured to limit the movement of the thrust bolt (22), particularly by means of an elongated transverse through hole (25) that houses a stop (26) solidly fixed to the supporting frame (11).

Preferably, the thrust bolt 22 is kept in contact with the limiter 24, either by means of a form-fit or a force-fit. In the figures, a force-fit caused by a spring (5) is illustrated, located between the limiter (24) and the ledge (19), and wherein the thrust bolt (22) is coaxially housed.

The head (10) can incorporate the punch holder (13) in a more distal position than the die holder (15), or vice versa. In the embodiment of the figures, the punch holder (13) is located in a more proximal position than the die holder (15).

According to the operation of the tool (1), as described below, starting from a situation wherein the frame (4) and the profile (6) are located between the punch holder (13) and the die holder (15), with the ferrule (9) of the profile (6) housed in the first eyelet (7) of the frame (4), protruding from the first eyelet (7), and with said ferrule (9) inserted between the punch (12) and the die (14). Then, the operator operates the tool (1) so that the power supply (17) activates the movement of the die holder (15), as indicated before, by means of the limiter (24) and the thrust bolt (22), such that the die holder (15) advances towards the punch holder (13) guided by the guide bolts (20) inside the guides (21), so that the punch (12) makes contact with the ferrule (9), pressing said ferrule (9) to expand it around the first eyelet (7).

To facilitate the location of the frame (4) and the profile (6) between the punch holder (13) and the die holder (15), the housing (16) is open, wherein the frame (10) is frontally configured to define the open housing (16).

1.-15. (canceled)

16. A tool for attaching the following elements equipped with flaps:
a frame of a solar panel, with a first flap with first eyelets; and
a profile of a solar tracker that supports the solar panel, with a second flap, with second eyelets in correspondence with the first eyelets, and with a ferrule made of material of the second flap, which surrounds the second eyelet, wherein each ferrule has a dimension slightly smaller than that of the corresponding first eyelet,
the tool comprising:
a head, intended to occupy, during use, a proximal position with respect to the solar panel and the profile, and with:
a supporting frame;
a punch mounted on a punch holder supported on the supporting frame;
a die supported on a die holder, linked to the supporting frame, the die facing the punch; and
a front open housing defined between the die and the punch, which enables the profile to be housed together with the frame prior to using the tool, the supporting frame being frontally configured to define the open housing;
a movement mechanism, to produce a relative approach between the punch and the die;
an actuator for driving the movement mechanism;
a power supply for electrical powering of the actuator; and
a handle, in a distal position, opposite the head, for gripping by an operator,
the head being configured so that, starting from a configuration with the frame and the profile between the punch holder and the die holder, and the ferrule of the profile housed in, and protruding from, the first eyelet, as well as with said ferrule inserted between the punch and the die, the relative movement of the die holder with respect to the punch holder causes the punch to make contact with the ferrule, pressing said ferrule, deforming it, to expand it around the first eyelet and attach the frame of the solar panel and the profile by means of the flaps.

17. The tool according to claim 16, wherein the power supply comprises a rechargeable battery.

18. The tool according to claim 16, wherein the power supply and the actuator are housed in the handle.

19. The tool according to claim 16, wherein the head incorporates the punch holder in a more proximal position than the die holder.

20. The tool according to claim 16, wherein the punch holder is fixed to the supporting frame, while the die holder is movably linked to the supporting frame, the movement mechanism being configured to act on the die holder, moving said die holder to bring it closer to the punch holder.

21. The tool according to claim 20, wherein the die holder is moveable from an initial position, wherein the die holder is supported on a ledge linked to, or comprised in the supporting frame, towards the punch holder.

22. The tool according to claim 20, wherein the die holder is fixed to a plurality of guide bolts, which pass through guides made in the ledge.

23. The tool according to claim 22, further comprising a thrust bolt that passes through the ledge through a through bore made in the ledge, to push the die holder to bring it closer to the punch holder.

24. The tool according to claim 16, further comprising a limiter to limit the movement of the die holder.

25. The tool according to claim 23,
further comprising a limiter to limit the movement of the die holder,
wherein the limiter is operable by means of the actuator, receiving a movement that is transmitted to the die holder through the thrust bolt, the limiter being configured to limit the movement of the thrust bolt.

26. The tool according to claim 25, wherein the limiter includes an elongated transverse through hole that houses a stop solidly fixed to the supporting frame.

27. The tool according to claim 24, further comprising a form-fit or a force-fit to keep the thrust bolt in contact with the limiter.

28. The tool according to claim 27, further comprising a spring, between the limiter and the ledge, and wherein the thrust bolt is coaxially housed, to cause the force-fit.

29. The tool according to claim 16, wherein the punch and the die are replaceable.

30. The tool according to claim 23,
wherein the die holder is moveable in a longitudinal direction,
wherein the guides are made in the ledge along the longitudinal direction; and
the through bore is made in the ledge along the longitudinal direction.

31. A method for attaching the following elements equipped with flaps:
a frame of a solar panel, with a first flap with first eyelets; and
a profile of a solar tracker that supports the solar panel, with a second flap, with second eyelets in correspondence with the first eyelets, and with a ferrule made of material of the second flap, which surrounds the second eyelet, wherein each ferrule has a dimension slightly smaller than that of the corresponding first eyelet, the tool;
the method comprising the steps of:
using a tool comprising:
a head, intended to occupy, during use, a proximal position with respect to the solar panel and the profile, and with:
a supporting frame;
a punch mounted on a punch holder supported on the supporting frame;
a die supported on a die holder, linked to the supporting frame, the die facing the punch; and
a front open housing defined between the die and the punch, which enables the profile to be housed together with the frame prior to using the tool, the supporting frame being frontally configured to define the open housing;
a movement mechanism, to produce a relative approach between the punch and the die;
an actuator for driving the movement mechanism;
a power supply for electrical powering of the actuator; and
a handle, in a distal position, opposite the head, for gripping by an operator,
the head being configured so that, starting from a configuration with the frame and the profile between the punch holder and the die holder, and the ferrule of the profile housed in, and protruding from, the first eyelet, as well as with said ferrule inserted between the punch and the die, the relative movement of the die holder with respect to the punch holder causes the punch to make contact with the ferrule, pressing said ferrule, deforming it, to expand it around the first eyelet and attach the frame of the solar panel and the profile by means of the flaps;
providing the frame and the profile, facing each other, and located between the punch holder and the die holder, with the ferrule of the profile housed in the first eyelet of the frame, protruding from the first eyelet, and with said ferrule inserted between the punch and the die; and
operating the tool so that the power supply activates the movement of the die holder, by means of the thrust bolt, such that the die holder advances towards the punch holder guided by the guide bolts inside the guides, so that the punch makes contact with the ferrule, pressing said ferrule to expand it surrounding the first eyelet, causing a form-fit that fixes the profile to the frame.
